(19) United States
(12) Patent Application Publication
(10) Pub. No.: US 2024/0344930 A1
(43) Pub. Date: Oct. 17, 2024

(54) DEVICE FOR ESTIMATING THE SIZE OF A SURFACE DEFECT OF A BEARING, AND ASSOCIATED METHOD AND BEARING DEVICE

(71) Applicant: Aktiebolaget SKF, Göteborg (SE)

(72) Inventors: Elizabertus MALJAARS, Houten (NL); Hendrik Anne MOL, Varik (NL)

(21) Appl. No.: 18/623,455

(22) Filed: Apr. 1, 2024

(30) Foreign Application Priority Data
Apr. 12, 2023 (DE) 102023203300.3

(51) Int. Cl. G01M 13/04; G06F 17/12

(52) U.S. Cl. CPC G01M 13/04; G06F 17/12

(57) ABSTRACT

A device (10) for estimating the size of a surface defect of a bearing (9). The device (8) includes a conditioning means (15), a first determining means (16), a second determining means (17), a solving means (18), a comparing means (19), a detecting means (20), and a third determining means (21).

### CROSS-REFERENCE TO RELATED APPLICATION

This application claims priority to German Application No. 102023203300.3, filed Apr. 12, 2023, the entirety of which is hereby incorporated by reference.

### FIELD

The present disclosure relates to monitoring of rolling bearings.

More particularly, the invention deals with a method and a device for estimating the size of a surface defect of a bearing, in particular a surface defect in a running surface of the bearing.

The invention further relates to a bearing device comprising such a device.

### BACKGROUND

Known acceleration-based vibration condition monitoring methods of the bearing are based on vibration signals detected by sensors attached on the bearing or surrounding the bearing.

The sensors are connected to monitoring devices implementing condition monitoring methods.

The methods permit to detect and identify a defect of the bearing, and attempts to evaluate the defect severity by estimating the size of a surface defect of bearings based on vibration signals.

The identification of a defect of the bearing is based on a comparison of the vibration signatures with known vibration signatures of bearing defects.

The evaluation of the defect severity is based on processing the vibration signals to detect the amplitude of the cyclostationary vibration excitations caused by the over rolling defects in bearings.

It is known that scalability between different machines comprising the sensors, and reproducibility on copies of same machine designs has been poor for acceleration-based vibration condition monitoring.

Further, severity quantification of a surface defect has not been robustly feasible using the common condition monitoring techniques such as acceleration-based vibration.

Moreover, known acceleration-based vibration condition monitoring methods have in common that they have been proven to work on clean laboratory equipment data but that in real conditions, to monitor bearings in machines, the presence of disturbances, the dynamics of the said machines and generally the deteriorated transfer paths of the vibrations from the source of vibrations to the sensors are blurring the defect signatures which may hide the defect signatures.

Consequently, the present invention intends to improve the accuracy of condition monitoring of a rolling bearing to enhance the evaluation of defect severities.

### SUMMARY

According to an aspect, a method for estimating the size of a surface defect of a bearing disposed inside a housing is proposed.

The bearing comprises a stationary ring surrounded by the housing and a rotating ring capable of rotating concentrically relative to the stationary ring, and rolling elements interposed between the stationary and rotating rings.

The housing comprises at least one recess inside which is disposed at least a displacement sensor.

The method comprises:
measuring, with the displacement sensor relative weighted displacement values between the housing and the stationary ring within the area of the recess, the weighted relative displacement being caused by rolling element forces on the stationary ring according to one position parameter comprising a rolling element position parameter representative of the position of the rolling elements relative to the displacement sensor, in particular spread in a loaded zone of the bearing,
determining intervals of position parameter values when rolling element position parameter values are associated to a maximum relative displacement value within a predetermined value, the maximum relative displacement value being equal to the maximum value of the weighted relative displacement values, the length of each interval being equal to a predetermined length,
determining a linear equation between the weighted relative displacement values of the intervals of position parameter values, a carrier function, and cyclostationary contact forces applied on at least one of the stationary ring, the rotating ring or rolling elements,
solving the linear equation to determine the cyclostationary contact forces applied on said at least one of the stationary ring, the rotating ring or rolling elements,
comparing the determined cyclostationary contact forces to a detection threshold,
detecting a surface defect on said at least the stationary ring, the rotating ring or rolling elements if the value of the cyclostationary contact forces is smaller than the detection threshold, and
determining the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

The method may be used to track multiple defects in the same bearing.

The entrance effect of the rolling element in a surface defect comprising a spall has much better visibility by observing weighted relative displacements than when by observing vibration, the weighted relative displacements being local displacements. When the rolling element exits the spall, a disproportional effect on vibration is observed which is reduced by observing the relative displacement compared to vibration.

The estimation of the cyclostationary contact forces permits to accurately predict the risk of failure of the bearing.

Advantageously, determining the linear equation and solving the linear equation comprises:
modelling the weighted relative displacement values with basis functions and basis function coefficients to obtain the carrier function,
for each interval, parametrizing the linear equation with basis functions and the at least one position parameter,
solving the parametrized equation to determine the basis coefficients, and
determining the cyclostationary contact forces from the basis coefficients and the weighted relative displacement values of each interval.

Preferably, determining the linear equation and solving the linear equation comprises:
determining a stabilizing equation to constraint the magnitude of cyclostationary contact forces and the inverse of the carrier function,
solving the linear equation taking into account the stabilizing equation to determine the basis coefficients of the cyclostationary contact forces and the inverse of the carrier function, and
determining the cyclostationary contact forces from the basis coefficients and the weighted relative displacement values of each interval.

Advantageously, the basis functions are B-splines or other functions having a local support.

Preferably, the position parameter further comprises the angular positions of the stationary and rotating rings relative to the rolling elements, and wherein the method comprises determining the cyclostationary contact forces applied on the rotating ring.

Preferably, the bearing further comprises at least one cage to maintain the circumferential spacing of the rolling elements, the position parameter further comprises the angular positions of the cage relative to the stationary ring, and the method comprises determining the cyclostationary contact forces applied on rolling elements.

Preferably, the position parameter further comprises the angular positions of the rolling elements relative to the stationary ring, and the method comprises determining the cyclostationary contact forces applied on the stationary ring.

Advantageously, the method further comprises predicting the propagation of the detected surface defect from the cyclostationary contact forces, the size of the surface defect, and a prediction model.

According to another aspect, a device for estimating the size of a surface defect of a bearing is proposed

The bearing is disposed inside a housing, the bearing comprising a stationary ring surrounded by the housing, and a rotating ring capable of rotating concentrically relative to the stationary ring, and rolling elements interposed between the stationary and rotating rings, the housing comprising at least one recess inside which is disposed a displacement sensor secured in the said recess.

The device comprises:
conditioning means configured to determine weighted relative displacement values between the housing and the stationary ring from signals delivered by the displacement sensor, the weighted relative displacement values being caused by rolling element forces on the stationary ring, and to associate each weighted relative displacement value to at least one position parameter value comprising a rolling element position parameter representative of the position of the rolling elements relative to the at least one displacement sensor,
first determining means configured to determine intervals of position parameter values when rolling element position parameter values are associated to a maximum relative displacement value within a predetermined value, the maximum relative displacement value being equal to the maximum value of the weighted relative displacement values, the length of each interval being equal to a predetermined length,
second determining means configured to determine a linear equation between the weighted relative displacement values of the intervals of position parameter values, a carrier function, and cyclostationary contact forces applied on at least one of the stationary ring, the rotating ring or rolling elements,
solving means configured to solve the linear equation to determine the cyclostationary contact forces applied on said at least one of the stationary ring, the rotating ring or rolling elements,
comparing means configured to compare the determined cyclostationary contact forces to a detection threshold,
detecting means configured to detect a surface defect on said at least the stationary ring, the rotating ring or rolling elements if the value of the cyclostationary contact forces is smaller than the detection threshold, and
third determining means configured to determine the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

According to another aspect, a bearing device provided with a housing comprising at least one recess in which is disposed a displacement sensor secured in the said recess, with a bearing disposed inside the housing and including a stationary ring surrounded by the housing, and a rotating ring capable of rotating concentrically relative to one another, rolling elements interposed between the stationary and rotating rings, and at least one cage to maintain the circumferential spacing of the rolling elements, and with a device as defined above and connected to the displacement sensor is proposed.

Preferably, the width of the recess in the axial direction of the bearing is smaller or equal than the length of the recess in the circumferential direction of the bearing.

Advantageously, the bearing device comprises a plurality of displacement sensors, each sensor being secured in a recess of the housing, the circumferential distance between two adjacent displacement sensors and their associated recesses being determined so that the circumferential distance is smaller than the circumferential distance between two rolling elements projected on the stationary ring.

Preferably, the plurality of displacement sensors comprises at least Z+1 sensors, Z been the number of rolling elements.

According to another aspect, a rotating machine comprising a bearing device as defined above is proposed.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a machine according to the present disclosure,

FIG. 2 illustrates schematically an example of a bearing device according to the present disclosure,

FIG. 3 illustrates a first example of a method for estimating the size of a surface defect of the bearing according to the present disclosure,

FIG. 4 illustrates an example of cyclostationary contact forces according to a position parameter according to the present disclosure,

FIG. 5 illustrates a second example of a method for estimating the size of a surface defect of the bearing according to the present disclosure,

FIG. 6 illustrates a first example of a grid of displacement sensors disposed on a bearing according to the present disclosure,

FIG. 7 illustrates an example of a temporal evolution of the signals delivered by an example of grid of displacement sensors according to the present disclosure,

FIGS. 8 and 9 illustrates a second example of a grid of displacement sensors disposed on a bearing according to the present disclosure, and

FIG. 10 illustrates a first example of a grid of displacement sensors disposed on a bearing to detect defects on the stationary ring, the rotating ring, and the rolling elements of the bearing according to the present disclosure.

### DETAILED DESCRIPTION

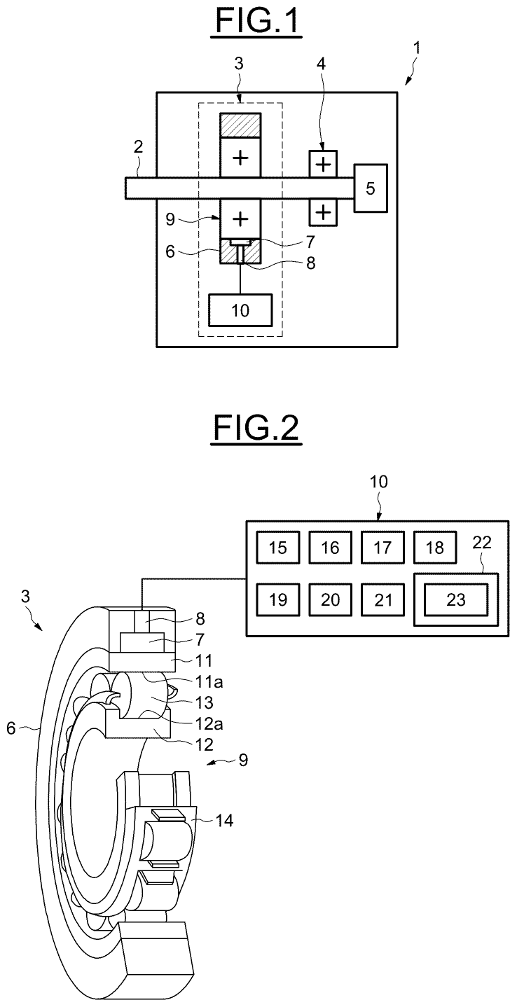

Reference is made to FIG. 1 which represents an example of a machine 1.

The machine 1 comprises a shaft 2 maintained in rotation by a bearing device 3 and a bearing 4.

The shaft 2 is for example driven by an electrical motor 5.

The bearing device 3 comprises a housing 6 comprising at least one recess 7 inside which is disposed a displacement sensor 8 secured in the said recess 7.

The recess 7 may be located in the housing 6 in a loaded zone of the bearing 6.

The housing 6 may comprise a plurality of recesses, each recess comprising a displacement sensor 8 disposed in the said recess 7.

The bearing device 3 further comprises a bearing 9 disposed inside the housing 6, and a device 10 connected to the displacement sensor 8.

Preferably, the plurality of recesses are located in loaded zones of the bearing 6.

The device 10 is connected to the sensor 8 with a wired connection or a wireless connection.

As represented on FIG. 1, the device 10 is located inside the machine 1.

In variant, the device 10 may be located outside the machine 1.

FIG. 2 illustrates schematically an example of the bearing device 3.

The bearing 9 including a stationary ring 11 and a rotating ring 12 capable of rotating concentrically relative to one another.

It is assumed that the stationary ring 11 is the outer ring of the bearing 6 and the rotating ring 12 is the inner ring of the bearing 6, the inner ring tightening the shaft 12.

The stationary ring 11 comprises a raceway 11a and the rotating ring 12 comprises a raceway 12a.

The bearing 9 further comprises rolling elements 13 interposed between the stationary and rotating rings 11, 12, and rolling on the raceways 11a, 12a of the stationary and rotating rings 11, 12.

At least one cage 14 maintains the circumferential spacing of the rolling elements 13.

The displacement sensor 8 measures a weighted relative displacement between the housing 6 and the stationary ring 11.

The displacement sensor 8 may be a non-contacting sensor so that the stationary ring may be arbitrarily mounted. No preferred circumferential orientation is defined contrary to the case where the sensor is a contacting sensor attached to the bearing's outer surfaces.

No contacting sensor allows replacement of the bearing as a mechanical part when it is worn, without having to remove or discard the displacement sensor 8, allowing economic use of installed condition monitoring systems.

The no contacting sensor comprises for example Eddy current sensor to determine the relative radial displacements, capacitive sensor, acoustic wave (ultrasonic) sensor, microwave sensor or light-based sensor.

In variant, the displacement sensor 8 may be a contacting sensor, for example spring loaded contacting sensor such a linear variable differential transformer (LVDT), piezo elements sensor, moving coil, moving magnet which may either sense the displacement itself or its first-time derivative (velocity) of the displacement allowing time integration to recover the weighted relative displacement of the surface.

The recess 7 may be a groove made for example a turning lathe in the housing 6.

It is advantageous to have local, machined recesses allowing just a few sensors 8 to have an observation of the movement of the stationary ring 11.

The recess 7 may be designed to offer stiffness outside the recess 7 for particular global mode shapes, and narrowing the deformation area for the local deformation to enhance the desired signature in terms of signal to noise ratio in the signals delivered by the sensor 8.

The recess shape may be designed using finite element analysis to optimize the quality of signals delivered by the sensor 8.

The width of the recess 7 in the axial direction of the bearing 9 may be smaller or equal than the length of the recess 7 in the circumferential direction of the bearing 9. The deformation shape is predominantly determined by the displacement on the side of the recess 7 instead of the displacement in the running direction of the bearing 9.

It may be advantageous to secure the stationary ring 11 and the housing 6 to avoid fretting corrosion, to offer stiffness, to stabilize the amplitude tolerances of signals delivered by the sensor 8 and to avoid distortion by stick slip of weighted relative displacements between the housing 6 and the stationary ring 11.

The stationary ring 11 and the housing 6 may be secured by interference fit between the outer diameter surface of the stationary ring 11 and the inner surface of the housing 6.

As represented on FIG. 2, the rolling elements 13 are rollers.

In variant, the rolling elements 13 may be balls.

The bearing 3 includes one raw of rolling elements 13. In variant, the bearing 3 may include more than one raw of rolling elements 13.

The device 10 comprises conditioning means 15, first determining means 16, second determining means 17, solving means 18, comparing means 19, detecting means 20, and third determining means 21.

The device 10 may further comprise predicting means 22 comprising a prediction model 23.

The predicting means 22 are located inside the device 10.

In variant, the predicting means 22 are located outside the device 10.

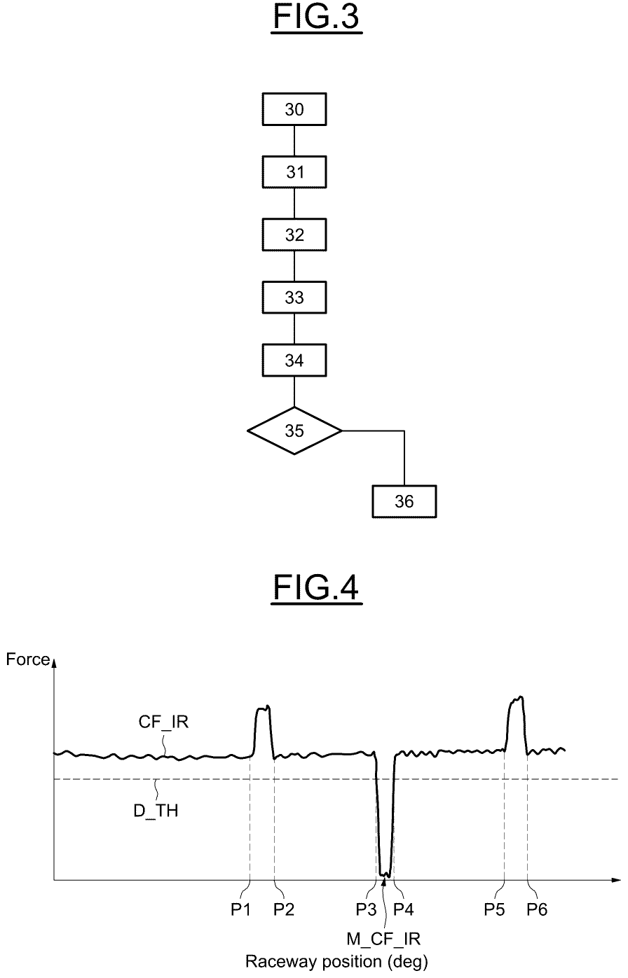

FIG. 3 illustrates a first example of a method for estimating the size of a surface defect of the bearing 9.

The method implements the device 10.

The surface defect may be located on the raceway 11a of the stationary ring 11, on the raceway 12a of the rotating ring 12, or on the outer surface of a rolling element 13 rolling on the raceways 11a, 12a of the stationary and rotating rings 11, 12.

In the following, it is assumed that the surface defect is located on the raceway 12a of the rotating ring 12, the method being implemented to detect the said surface defect.

Under constant rolling element force, the weighted relative displacement values measured by the displacement sensor 8 is periodic and is function of a rolling element position parameter psi(t) representative of the position of the rolling elements relative to displacement sensor 7.

The rolling element position parameter psi(t) depends on time t.

It is assumed that the weighted relative displacement generated by the rolling element force on the rotating ring 12 is linear, the measured weighted relative displacement d_local(t) depending on time so that:

$$d\_local ( t ) = CA ( psi ( t ) ) * CF\_IR ( t ) \qquad ( 1 )$$

where CA is a carrier function and CF_IR(t) is the cyclostationary contact forces applied on the stationary ring 11.

In a step 30, the sensor 8 delivers signals comprising weighted relative displacement values caused by rolling element forces on the stationary ring 11.

In a step 31, the conditioning means 15 determine the weighted relative displacement values d_local(t) from signals delivered by the displacement sensor 8 and associate each displacement value d_local(t) to a position parameter value comprising the rolling element position parameter psi(t) and the angular position parameter IRphase of the stationary and rotating rings 11, 12 relative to the rolling elements 13.

In a step 32, the first determining means 16 determine intervals of position parameter values when values of the rolling element position parameter psi(t) are associated to a maximum relative displacement magnitude d_max within a predetermined value pv so that the intervals comprise measured weighted relative displacement values d_local(t_vic) at the vicinity of the sensor 8.

$$d\_local ( t\_vic ) = CA ( psi ( t\_vic ) ) * CF\_IR ( t\_vic ) \qquad ( 2 )$$

The predetermined value pv is chosen such that the relative displacement values d_local(t_vic) of each interval are taken in a circumferential distance equal for example to 10% of the rolling element distance between two adjacent rolling elements 13 and centered around the peak of the displacement waveform delivered by the sensor 8.

The length of each interval is equal to a predetermined length equal for example to 20% of the rolling element distance.

In a step 33, the second determining means 17 determine a linear equation between the weighted relative displacement magnitudes of the intervals of position parameter values, the carrier function CA, and the cyclostationary contact forces CF_IR(t) applied on the rotating ring 12, and the solving means 18 solve the linear equation determined by the second determining means 17.

The second determining means 17 model the weighted relative displacement values d_local(t) with basis functions in a matrix M_CA and basis function coefficients x_CA to obtain the carrier function CA.

The basis functions in the matrix M_CA are functions having a local support, for example B-splines obtained for example with the de Boor's algorithm.

Such functions allow reliable and unique estimations of the carrier CA and cyclostationary contact forces CF_IR(t) from the weighted relative displacement values.

In determining the carrier function CA it is assumed that all cyclostationary contact forces CF_IR(t) on the rotating ring 11 is a noise term having the property that it is a stochastic symmetric distribution with unit mean.

The matrix M_CA is determined from the following least squares problem:

$$d\_local ( t\_vic ) = M\_CA ( psi ( t\_vic ) ) * x\_CA \qquad ( 3 )$$

The matrix M_CA is a full column rank matrix (having small condition number, e.g. less than 10) so that all basis function coefficients x_CA are uniquely estimated from the measured relative displacement d_local(t).

The carrier function CA as a function of the rolling element position parameter psi(t) in the vicinity of the sensor 8 is as follow:

$$CA ( psi ( t\_vic ) ) = M\_CA ( psi ( t\_vic ) ) * x\_CA \qquad ( 4 )$$

When the carrier function CA is determined, for each interval, the second determining means 17 parametrize the linear equation (1) with basis functions M_CA, the position parameter comprising the rolling element position parameter psi(t), and an angular position parameter RE_on_IR_phase.

The linear equation (2) in the vicinity of the sensor 7 is equal to:

$$d\_local ( t\_vic ) = CA ( psi ( t\_vic ) ) * CF\_IR ( t\_vic ) \qquad ( 5 )$$

$$CF\_IR ( t\_vic ) = M\_IR ( RE\_phase ( t\_vic ) ) * x\_IR$$

where cyclostationary contact forces CF_IR(t) on the rotating ring 12 is parametrized with the B-Splines, M_IR and x_IR are the basis function matrix and the basis function coefficients vector, and RE_ on IR phase is the phases of the rolling elements 13 and the rotating ring 12 with respect to the position of the sensor 8 on the stationary ring 11 to take into account that the rolling element force is estimated at the point of contact between the stationary ring 11 and the rotating ring 12.

The parameter RE_on_IR phase is defined as follows:

$$RE\_on \_IR phase ( t\_vic ) = mod ( IRphase ( t\_vic ) - psi ( t\_vic ) / nRE , psi\_domain ) \qquad ( 6 )$$

where nRE is the number of rolling elements 13 in the bearing 9 and mod is an operator wrapping the signal at the chosen psi_domain (e.g. degrees or pi).

Equation (5) is rewritten as following:

$$d\_local ( t\_vic ) = [ \text{} diag ( CA ( psi ( t\_vic ) ) ) * M\_IR ( RE\_on \_IR \_phase ( t\_vic ) ) * x\_IR ] * x\_IR \qquad ( 6 )$$

where the carrier psi(t_vic) is evaluated using equation (3).

Equation (6) is a least squares problem.

The solving means 18 solve equation (6) to determine the cyclostationary contact forces CF_IR(t) equal to M_IR(RE_on_IR phase(t_vic))*x_IR.

The cyclostationary contact forces CF_IR(t) are determined from the basis coefficients and the weighted relative displacement values of each interval.

In step 34, the comparing means 19 compare the determined cyclostationary contact forces CF_IR to a detection threshold D_TH.

If a value of the cyclostationary contact forces CF_IR is smaller than the detection threshold D_TH (step 35), the detecting means 20 detect that the rotating ring 12 has a surface defect.

Then the detecting means 20 have detected that the step 35 rotating ring 12 has a surface defect (step 36), the third determining means 21 determine the size of the surface defect from the intervals of position parameter from the position parameter values associated with cyclostationary contact forces smaller than the detection threshold D_TH.

FIG. 4 illustrates an example of the cyclostationary contact forces CF_IR according to the position parameter comprising the angular position of a reference point on the raceways 12a of the rotating ring 12 relative to the sensor 8 determined by the first example of a method for estimating the size of a surface defect of the bearing 9.

When the angular position is in the range [P1, P2] and [P5, P6], the cyclostationary contact forces CF_IR are higher than the mean value of the said contact forces.

When the angular position is in the range [P3, P4] the said contact forces are less than the mean value and the detection threshold D_TH.

The minimum level of the said contact forces is noted M_CF_IR and is due to rolling elements 13 rolling through a defect.

The level M_CF_IR is equal to or larger than zero as the rolling contact forces may not be completely lost.

The level M_CF_IR gives information about the depth and width of the defect.

As the cyclostationary contact forces CF_IR are less than the mean value and the detection threshold D_TH, the detecting means 20 detect the surface defect on the raceway 12a.

In this example, when the rolling elements 13 roll on the deep surface defect (range [P3, P4]), the rolling elements 13 do not enter in contact with the rotating ring 10 so the sensor 8 measures a relative displacement nearly nil.

The cyclostationary contact forces CF_IR are higher in the range [P1, P2] and [P5, P6] to compensate the contact loss between the rolling elements 13 and the module ring 12.

The third determining means 21 determine the size of the surface defect.

The size of the surface defect is defined by three parameters represented for example by vectors.

A first vector defines the length of the size of the surface defect and is oriented in the rolling direction.

A second vector defines the width of the size of the surface defect and is oriented in the axial direction of the bearing.

The third vector defines the depth of the size of the surface defect and is oriented in the radial direction of the bearing, perpendicular to both the length vector and the width vector.

The depth of the size of the surface defect is determined from the level M_CF_IR.

Further the level M_CF_IR is used to track for example the propagation of a spall in the bearing.

The distance associated to the angular sector defined by the range [P3, P4] in which the contact forces CF_IR are below the detection threshold D_TH gives the length of the surface defect.

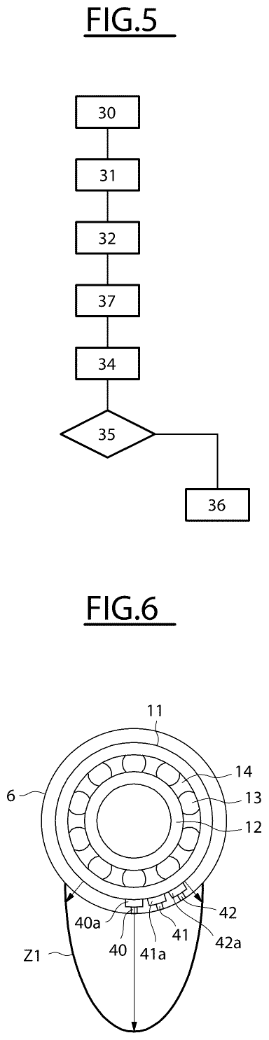

FIG. 5 illustrates a second example of the method for estimating the size of a surface defect of the bearing 9.

The second example of the method comprises the steps 30 to 32 as defined above.

In a step 37, the second determining means 17 determine a stabilizing equation to constraint the magnitude of cyclostationary contact forces CF_IR(t) on the rotating ring 12 and the inverse of the carrier function CA, and the solving means 18 solve the linear equation taking into account the stabilizing equation to determine the basis coefficients x_CA, the cyclostationary contact forces CF_IR(t), and the inverse CA_inv of the carrier function CA.

Starting from equation (2):

$$d\_local ( t\_vic ) = CA ( psi ( t\_vic ) ) * CF\_IR ( t\_vic ) \qquad ( 2 )$$

this equation is rewritten in equation (7) as follow:

$$d\_local ( t\_vic ) * CA\_inv ( psi ( t\_vic ) ) = CF\_IR ( t\_vic ) \qquad ( 7 )$$

The inverse carrier CA_inv and the cyclostationary contact forces CF_IR(t) are parameterised using for example B-splines/

Equation (7) is rewritten as follow:

(diag(d_local(t_vic))*M_CA_inv(psi(t_vic)))*x_CA_inv=M_IR(IRphase(t_vic),psi(t_vic))*x_IR (7)
where M_CA_inv is the matrix with basis functions for the inverse carrier parameterization and x_CA_inv is the corresponding basis function coefficients vector.

Equation (7) may be rewritten as follow:

$$A * x = b \qquad ( 8 )$$

$$where$$

$$A = [ diag ( d\_local ( t\_vic ) ) * M\_CA \_inv ( psi ( t\_vic ) ) , \\ M\_IR ( IRphase ( t\_vic ) , psi ( t\_vic ) ) ] \qquad ( 9 )$$

and where x is a stacked vector of the form

$$x = [ x\_CA \_inv \hat{} T x\_IR \hat{} T ] \hat{} T \qquad ( 10 )$$

However, one direction is unconstrained, basically the scaling of the inverse carrier CA_inv and the cyclostationary contact forces CF_IR, therefore an additional stabilizing equation A_stab*x=b (at least one row in A_stab that is spanning the null space of A) is added, to keeps the inverse carrier CA_inv close to one when the RE is below the sensor:

$$A\_final = [ A \text{} A\_stab ] , \text{} b\_final = [ \text{} b b\_stab ] and A\_final * x\_final = b\_final \qquad ( 11 )$$

Solving equation (8) yields the estimates for the inverse carrier basis function parameters x_CA_inv.

The cyclostationary contact forces CF_IR may be evaluated using x_IR again at any desired grid. An additional weighting matrix W can be used to let the solution concentrate on the center of the carrier, resulting in a weighted least squares problem.

As this problem is well posed, it can also be written as a compact QP problem that can be solved when limited memory is available.

In the present example of a surface defect on the raceway 12a of the rotating ring 12, the cyclostationary force CF_IR include the contact forces on the rotating ring 12. In the general case, the cyclostationary force CF_IR is replaced by cyclostationary force CF_int which may also include the contact forces on the rotating ring 12 and the contact forces on the stationary ring 11 and/or rolling elements 13.

After the cyclostationary contact forces CF_IR are determined, the method continues with steps 34, 35, 36.

When the device 10 comprises the predicting means 22, the predicting means 22 predict the propagation of the detected surface defect from the cyclostationary contact forces CF_IR or CF_int, the size of the surface defect, and the prediction model 23.

The method may determine the cyclostationary contact forces applied on rolling elements 13 determine a surface defect on a rolling element 13, the position parameter further comprising the angular positions of the cage 14 relative to the stationary ring 11.

An observer may provide the rolling element defect frequency and the method may be used to determine the defect length.

This may give robust results on roller bearings, whereas the results on ball bearings are more intermittent and hence give more averaged results, still indicating the defect size.

Rolling element defects may be handled in the same way as rotating ring defects, assuming that an intermittent cyclostationary signature is visible with the duration of the interval.

The method may determine the cyclostationary contact forces applied on the stationary ring 11 to determine a surface defect on the stationary ring 11, the position parameter further comprising the angular positions of the rolling elements 13 relative to the stationary ring 11.

To detect a surface on the stationary ring 11, a suitable displacement sensor configuration is needed, which is detailed below.

For the detection of a surface defect on the stationary ring 11, the first example of the method shall be used with a fixed (chosen or calibrated based on data or models) carrier.

The contributions of the cyclostationary contact forces applied on rolling elements 13 and of the cyclostationary contact forces applied on the stationary ring 11 may be added to equation (1) such that surface defects at multiple components (rolling elements 13, stationary ring 11) may be estimated simultaneously.

The phases of the rotating ring 12 and rolling element 13 position may be measured explicitly with additional sensors, e.g. magnetic sensors that feel the passage of the rolling element 13 and e.g. shaft encoders. The information is however also implicitly embedded in the weighted relative displacement signals and can be estimated simultaneously using a suitable observer, such as (Extended/Unscented) Kalman Filters or the construction of a (nonlinear) optimization problem that provides next to the carrier and cyclostationary force waveform also the phases of rotating components.

In the following, the position of at least the displacement sensor 8 is exposed according to the component to be monitored.

As exposed, to determine a surface defect on the rotating ring 12, the sensor 8 is disposed on the stationary ring 11 on the most loaded zone of the bearing 9.

To determine a surface defect on rotating elements 13, the sensor 8 is disposed on the stationary ring 11 on the most loaded zone of the bearing 9.

To detect a defect on the stationary ring 11, a plurality of displacement sensors are disposed on the stationary ring 11.

The circumferential distance between two adjacent displacement sensors and their associated recesses is determined so that the circumferential distance is smaller than the circumferential distance between two rolling elements projected on the stationary ring.

To achieve sufficiently observability, a grid of displacement sensors is needed within a rolling element 13 distance near the top of the loaded zone. The circumferential distance between two rolling elements 13 is dictated by minimal the ceiling of the following ratio: rolling element distance RE_D on the stationary ring raceway 11a over the localized footprint width psi_vic. Here, the latter being the psi_vic converted in mm distance on the stationary ring raceway 11a. This grid of sensors can be part of a more extensive sensor configuration with several of these groups in order to deal with loaded zone changes.

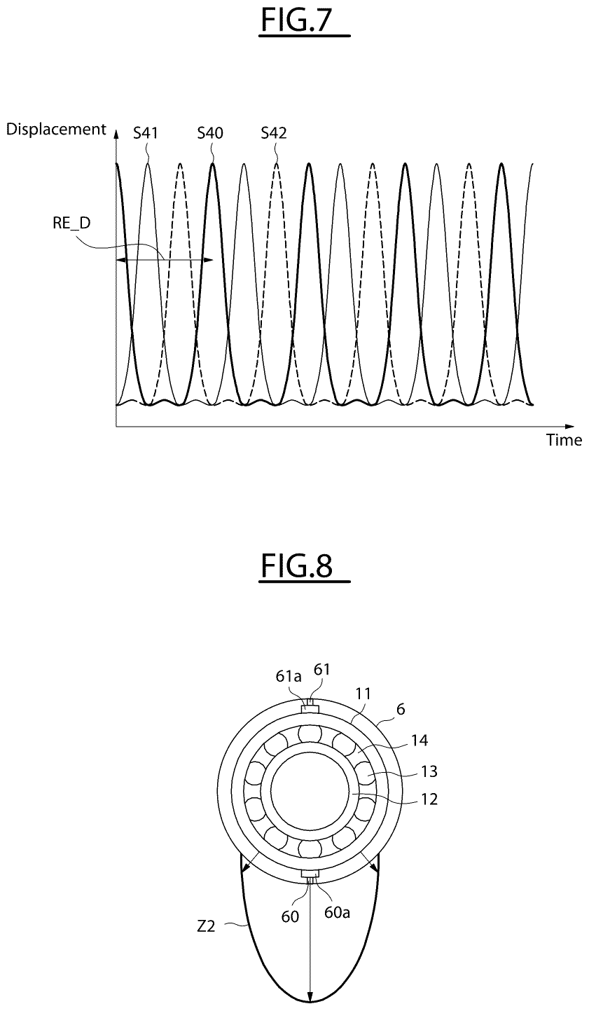

The sensor configuration is illustrated on FIGS. 6 and 7.

FIG. 6 illustrates a first example of a grid of displacement sensors 40, 41, 42, each sensor 40, 41, 42 being secured in a recess 40a, 41a, 42a of the housing 6, the sensors 40, 41, 42 and their associated recesses being disposed in the loaded zone Z1 to detect a defect on the stationary ring 11.

The displacement sensors 40, 41, 42 forming a group of sensors are disposed on the stationary ring 11 as explained above.

FIG. 7 illustrates an example of a temporal evolution of the signals S40, S41, S42 delivered respectively by the sensors 40, 41, 42.

The sensors 40, 41, 42 are disposed on the stationary ring 12 so that the overlap of the signals S40, S41, S42 is sufficient, the overlap is governed by the rolling element distance RE_D over the localized footprint width psi_vic.

In the presence of multiple loaded zones which may switch over time for example in a gearbox, a displacement sensor may be disposed in each loaded zone to determine a surface defect on the rotating ring 12 and/or rolling elements 13.

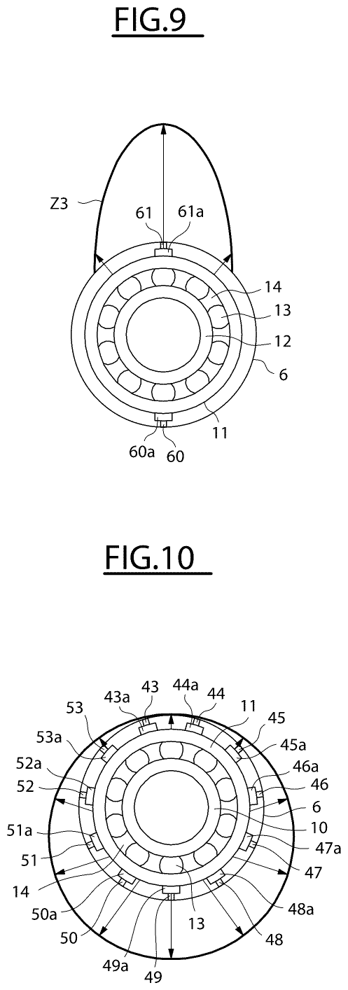

FIGS. 8 and 9 illustrates a second example of a grid of displacement sensors 60, 61.

Each sensor 60, 61 is secured in a recess 60a, 61a of the housing 6, the sensors 60, 61 and their associated recesses 60a, 61a being disposed on the stationary ring 11 in a first loaded zone Z2 and a second loaded zone Z3 to detect a defect on the stationary ring 11, for example in a gearbox.

The first loaded zone Z2 and the second loaded zone Z3 switch over time.

In this example, the first displacement sensor 60 forming a first group of sensor(s) is disposed in the first loaded zone Z2 and the second displacement sensor 61 forming a second group of sensor(s) is disposed in the second loaded zone Z3 opposite of the first displacement sensor 60.

The load transfer from the rolling element loosing contact force due to defect to the other rolling elements in the loaded zone near the sensor(s) needs to be taken into account.

The first group of sensor may comprise more than one sensor, the circumferential distance between two adjacent displacement sensors of the first group of sensors and their associated recesses is determined so that the circumferential distance is smaller than the circumferential distance between two rolling elements projected on the stationary ring.

Similarly, the second group of sensor may comprise more than one sensor, the circumferential distance between two adjacent displacement sensors of the second group of sensors and their associated recesses is determined so that the circumferential distance is smaller than the circumferential distance between two rolling elements projected on the stationary ring.

FIG. 10 illustrates a first example of a grid of displacement sensors to detect defects on the stationary ring 11, the rotating ring 12, and the rolling elements 13.

The example of the grid of displacement sensors comprises Z+1 sensors, Z being the number of rolling elements 13.

In this example, the bearing 9 is full loaded and comprises ten rolling elements 13 and the grid of displacement sensors comprises eleven displacement sensors 43, 44, 45, 46, 47, 48, 49, 50, 51, 52, 53.

Each displacement sensor 43, 44, 45, 46, 47, 48, 49, 50, 51, 52, 53 is secured in a recess 43a, 44a, 45a, 46a, 47a, 48a, 49a, 50a, 51a, 52a, 53a.

The displacement sensor 43, 44, 45, 46, 47, 48, 49, 50, 51, 52, 53 and their associated recesses 43a, 44a, 45a, 46a, 47a, 48a, 49a, 50a, 51a, 52a, 53a are regularly disposed on the stationary ring 12.

When the loaded zone does not span the full circumference, the displacement sensors are disposed on the stationary ring 11 in the loaded zone, the number of displacement sensors being equal to the number of rolling elements 13 in the loaded zone plus one.

The entrance effect of the rolling element 13 in a surface defect comprising a spall has much better visibility in displacement domain than when observed with vibration. When the rolling element 13 exits the spall, a disproportional effect on vibration is observed which is reduced by observing the weighted relative displacement compared to vibrations.

The exit contact force looks much more similar to the entry contact force than the vibration response does. The main transfer function between sensor and excitation sources (rolling elements 13) as in vibration is avoided. High frequent resonances dominate acceleration response.

The signature does not change significantly with running speed and load. Deterministic excited rigid body modes are modestly present in the reconstructed load waveforms. The magnitude of the excitation depends on the load and is easy to handle in signal processing. As such the method is scalable to all speed ranges. It is also well applicable at very low speeds where acceleration often fails and provided a sufficiently long observation time that reveals the cyclostationary behaviour of interest.

The estimation of the cyclostationary contact forces permits to accurately predict a risk of failure of the bearing 6.

In the second example of the method, a single recording is sufficient to provide the defect size estimate.

The method may be used to track multiple defects in the same bearing.

1. A method for estimating the size of a surface defect of a bearing disposed inside a housing, the bearing comprising a stationary ring surrounded by the housing and a rotating ring capable of rotating concentrically relative to the stationary ring, and rolling elements interposed between the stationary and rotating rings, the housing comprising at least one recess inside which is disposed at least a displacement sensor, the method comprising:
measuring, with the displacement sensor weighted relative displacement values between the housing and the stationary ring within the area of the recess, the weighted relative displacement being caused by rolling element forces on the stationary ring according to one position parameter comprising a rolling element position parameter representative of the position of the rolling elements relative to the displacement sensor, in particular spread in a loaded zone of the bearing,
determining intervals of position parameter values when rolling element position parameter values are associated to a maximum relative displacement value within a predetermined value, the maximum relative displacement value being equal to the maximum value of the weighted relative displacement values, the length of each interval being equal to a predetermined length,
determining a linear equation between the weighted relative displacement values of the intervals of position parameter values, a carrier function, and cyclostationary contact forces applied on at least one of the stationary ring, the rotating ring or rolling elements,
solving the linear equation to determine the cyclostationary contact forces applied on said at least one of the stationary ring, the rotating ring or rolling elements,
comparing the determined cyclostationary contact forces to a detection threshold,
detecting a surface defect on said at least the stationary ring, the rotating ring or rolling elements if the value of the cyclostationary contact forces is smaller than the detection threshold, and
determining the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

2. The method according to claim 1, wherein determining the linear equation and solving the linear equation comprises:
modelling the weighted relative displacement values with basis functions and basis function coefficients to obtain the carrier function,
for each interval, parametrizing the linear equation with basis functions and the at least one position parameter,
solving the parametrized equation to determine the basis coefficients, and
determining the cyclostationary contact forces from the basis coefficients and the weighted relative displacement values of each interval.

3. The method according to claim 1, wherein determining the linear equation and solving the linear equation comprises:
determining a stabilizing equation to constraint the magnitude of cyclostationary contact forces and the inverse of the carrier function,
solving the linear equation taking into account the stabilizing equation to determine the basis coefficients of the cyclostationary contact forces and the inverse of the carrier function, and
determining the cyclostationary contact forces from the basis coefficients and the weighted relative displacement values of each interval.

4. The method according to claim 2, wherein the basis functions are B-splines or other functions having a local support.

5. The method according to claim 1, wherein the position parameter further comprises the angular positions of the stationary and rotating rings relative to the rolling elements, and wherein the method comprises determining the cyclostationary contact forces applied on the rotating ring.

6. The method according to claim 1, the bearing further comprising at least one cage to maintain the circumferential spacing of the rolling elements, wherein the position parameter further comprises the angular positions of the cage relative to the stationary ring, and wherein the method comprises determining the cyclostationary contact forces applied on rolling elements.

7. The method according to claim 1, wherein the position parameter further comprises the angular positions of the rolling elements relative to the stationary ring, and wherein the method comprises determining the cyclostationary contact forces applied on the stationary ring.

8. The method according to claim 1, further comprising predicting the propagation of the detected surface defect from the cyclostationary contact forces, the size of the surface defect, and a prediction model.

9. The method according to claim 3, wherein the basis functions are B-splines or other functions having a local support.

10. The method according to claim 9, wherein the position parameter further comprises the angular positions of the stationary and rotating rings relative to the rolling elements, and wherein the method comprises determining the cyclostationary contact forces applied on the rotating ring.

11. The method according to claim 9, the bearing further comprising at least one cage to maintain the circumferential spacing of the rolling elements, wherein the position parameter further comprises the angular positions of the cage relative to the stationary ring, and wherein the method comprises determining the cyclostationary contact forces applied on rolling elements.

12. The method according to claim 9, wherein the position parameter further comprises the angular positions of the rolling elements relative to the stationary ring, and wherein the method comprises determining the cyclostationary contact forces applied on the stationary ring.

13. The method according to claim 12, further comprising predicting the propagation of the detected surface defect from the cyclostationary contact forces, the size of the surface defect, and a prediction model.

14. A device for estimating the size of a surface defect of a bearing disposed inside a housing, the bearing comprising a stationary ring surrounded by the housing, and a rotating ring capable of rotating concentrically relative to the stationary ring, and rolling elements interposed between the stationary and rotating rings, the housing comprising at least one recess inside which is disposed a displacement sensor secured in the said recess, the device comprising:
a conditioning means configured to determine weighted relative displacement values between the housing and the stationary ring from signals delivered by the displacement sensor, the weighted relative displacement values being caused by rolling element forces on the stationary ring, and to associate each weighted relative displacement value to at least one position parameter value comprising a rolling element position parameter representative of the position of the rolling elements relative to the at least one displacement sensor,
a first determining means configured to determine intervals of position parameter values when rolling element position parameter values are associated to a maximum relative displacement value within a predetermined value, the maximum relative displacement value being equal to the maximum value of the weighted relative displacement values, the length of each interval being equal to a predetermined length,
a second determining means configured to determine a linear equation between the weighted relative displacement values of the intervals of position parameter values, a carrier function, and cyclostationary contact forces applied on at least one of the stationary ring, the rotating ring or rolling elements,
a solving means configured to solve the linear equation to determine the cyclostationary contact forces applied on said at least one of the stationary ring, the rotating ring or rolling elements,
a comparing means configured to compare the determined cyclostationary contact forces to a detection threshold,
a detecting means configured to detect a surface defect on said at least the stationary ring, the rotating ring or rolling elements if the value of the cyclostationary contact forces is smaller than the detection threshold, and
a third determining means configured to determine the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

15. A bearing device comprising:
a housing comprising at least one recess in which is disposed a displacement sensor secured in the said recess,
a bearing disposed inside the housing, the bearing including a stationary ring surrounded by the housing, a rotating ring capable of rotating concentrically relative to one another, rolling elements interposed between the stationary and rotating rings, and at least one cage to maintain the circumferential spacing of the rolling elements, and
a device according to claim 14 connected to the displacement sensor.

16. The bearing device according to claim 15, wherein the width of the recess in the axial direction of the bearing is smaller or equal than the length of the recess in the circumferential direction of the bearing.

17. The bearing device according to claim 15, comprising a plurality of displacement sensors, each sensor being secured in a recess of the housing, the circumferential distance between two adjacent displacement sensors and their associated recesses being determined so that the circumferential distance is smaller than the circumferential distance between two rolling elements projected on the stationary ring.

18. The bearing device according to claim 16, comprising a plurality of displacement sensors, each sensor being secured in a recess of the housing, the circumferential distance between two adjacent displacement sensors and their associated recesses being determined so that the circumferential distance is smaller than the circumferential distance between two rolling elements projected on the stationary ring.
